(19) United States
(12) Patent Application Publication
(10) Pub. No.: US 2019/0015774 A1
(43) Pub. Date: Jan. 17, 2019

(54) REUSABLE AIR FILTER WITH REPLACEABLE CAPSULE

(71) Applicant: Flow Filters Corp., Ottawa (CA)

(72) Inventors: Tristan Tirone, Tottenham (CA); Brian Camenzuli, Oshawa (CA)

(73) Assignee: Flow Filters Corp., Ottawa (CA)

(21) Appl. No.: 16/031,233

(22) Filed: Jul. 10, 2018

Related U.S. Application Data
(60) Provisional application No. 62/531,561, filed on Jul. 12, 2017.
(60) Provisional application No. 62/642,749, filed on Mar. 14, 2018.

(51) Int. Cl. B01D 53/04; B01D 46/00; B01D 39/08; A24D 3/06; A24D 3/16

(52) U.S. Cl. CPC B01D 53/0415; B01D 46/0005; B01D 46/0045; B01D 46/0036; B01D 2257/708; A24D 3/068; A24D 3/163; B01D 2253/102; B01D 39/083

(57) ABSTRACT

A filtration apparatus for filtering air is described. It includes a disposable capsule defining an absorptive material space to hold a volume of absorptive material, where the disposable capsule further defines a set of capsule fluid inlets to permit fluid to move through the disposable capsule into and out of the absorptive material space. The apparatus further includes a reusable frame to support the disposable capsule, where the reusable frame defines a frame fluid inlet and the reusable frame is removably couplable to the disposable capsule to direct fluid passing through the filtration apparatus through a fluid passage through the frame fluid inlet and the absorptive space of the disposable capsule. Also disclosed is a set of injection molding molds for forming a filtration apparatus.

### FIELD OF THE INVENTION

The present specification relates generally to air filters, and specifically to reusable air filters which include a disposable filter capsule.

### BACKGROUND OF THE INVENTION

Filters have been used for many years to purify air. For example, activated carbon air filters, which are often in the can style shape, are used in the hydroponic space, among many other industries, for odour eliminating and Volatile Organic Compound (‘VOC’) control qualities.

Activated carbon filters are typically available in various flange sizes and dimensions, such as 4 to 16-inch flange and 10 to 80-inch length. Such filters are also often defined or measured according to their rated Cubic Feet per Minute (‘CFM’) output level, such as 50 to 4000 cfm.

Can filters are typically provided for attachment to an inline fan via a flange, which fan outputs CFM levels matching the capacity of the corresponding filter. Typically, the inline fan is a separate unit from the filter, however they are interdependent since a fan is necessary for proper function of the filter. An inline fan may exhaust air through the filter or may suck air into the filter through an intake/exhaust/inline method, and typically sucks air into the filter. Particles in the air may then be trapped by the activated carbon in the filter, which may reduce odor or VOC in the dispensed air. Such filters often also include additional ducting and clamps to connect the filter to the inline fan, given the spacing and positioning requirements of the setup.

Where activated carbon is used, at some point the absorption capacity of the activated carbon is reduced to the point where the activated carbon is considered to have expired, for example once enough particles have been trapped by the carbon or once the carbon has absorbed a predetermined weight its particle trapping function is understood to have expired. Once this happens, that whole unit is often understood to have become obsolete and in need of replacement, which typically involves repurchasing the entire unit as the activated carbon is not typically independently replaceable.

Carbon filters are often also used to eliminate dust, pollen, and humidity from an enclosed area, and to generally improve the air quality and air odor. The standard activated carbon air filters available commercially are not reusable and require the entire filter unit to be replaced after the carbon expires, typically after 1 to 2 years of use.

While some commercially available filters include reversible components, such as those allowing a user to flip the flange of a filter end-to-end to more fully utilize the entire volume of absorptive material, the carbon still eventually expires, and the entire unit needs to be replaced; as such, the filters are not as reusable as may be desired. In addition, such reversible filters may not be favoured by consumers, such as being perceived as yielding inferior odour elimination and VOC control function or being perceived as a marketing ploy as the reversal is not necessary since air passing through the filter will follow the path of least resistance anyway.

Some other commercially available filters allow users to replace carbon sheets in the filter. However, as gasket systems and other sealing systems or components or features wear down, the filters tend to lose functionality such as by becoming insufficiently sealed. Additionally, systems employing carbon sheets may not be as effective as those using a volume of biochar or activated carbon or similar absorptive material, which may result in shorter life of the replacement components or reduced effectiveness of the filter. Customers may also not favour this type of filter and may perceive it as having functionality and cost issues. Many also use a box shape rather than a more convenient can shape.

Many carbon air filters on the market utilize granular or pelletized activated carbon. Many use rc/48 and rc/412 Australian activated carbon, which may be sieved to meet dimension requirements to maximize filtration.

Many commercially available filters can be disassembled by a user possessing intermediate mechanical skills and power tools, enabling the user to refill a carbon fill by opening a containing space and removing the volume of activated carbon and replacing it with a fresh volume of activated carbon. However, this can be a very tedious and messy process. Additionally, this is inefficient, as the carbon typically requires machine packing to maximize filtering efficiency.

As many commercially available filters are disposable and use steel or other metals, or do not offer long term effective filtration, they may not satisfy consumer demand for sustainable effective filtration and may increase costs for consumers.

Additionally, the continued use of activated carbon as opposed to other, more sustainable, more cost effective, and more absorptive materials may also fail to satisfy consumer desire.

Existing commercially available filters may also use vent hole designs or configurations which do not provide ideal functionality.

Existing commercially available filters may also not adequately provide for the personal use market; products for use with personal inhalation devices or systems.

### SUMMARY OF THE INVENTION

In an embodiment of the present invention, there is provided a filtration apparatus for filtering air, comprising a disposable capsule defining an absorptive material space to hold a volume of absorptive material, the disposable capsule further defining a set of capsule fluid inlets to permit fluid to move through the disposable capsule into and out of the absorptive material space; and a reusable frame to support the disposable capsule, the reusable frame defining a frame fluid inlet, and wherein the reusable frame is removably coupled to the disposable capsule to direct fluid passing through the filtration apparatus through a fluid passage through the frame fluid inlet and the absorptive space of the disposable capsule.

In an embodiment of the present invention, there is provided a set of injection molds for forming a disposable air filter capsule, comprising a frame end injection mold for forming a reusable frame defining a frame inlet; an end cap injection mold for forming an end cap; and at least one capsule injection mold for forming a replaceable capsule defining an absorptive material space, wherein the resalable frame, end cap, and replaceable capsule are configurable to form a filtration apparatus defining a fluid passage through the frame inlet and the absorptive material space.

### BRIEF DESCRIPTION OF DRAWINGS

The principles of the invention may better be understood with reference to the accompanying figures provided by way of illustration of an exemplary embodiment, or embodiments, incorporating principles and aspects of the present invention, and in which:

FIG. 1 is a perspective rear view of a can-style filter, according to an embodiment;

FIG. 2 is a perspective front view of the filter of FIG. 1;

FIG. 3 is a front elevation view of the filter of FIG. 1;

FIG. 4 is a back elevation view of the filter of FIG. 1;

FIG. 5 is a perspective sectional view taken along line 5-5 of FIG. 4;

FIG. 6 is a perspective sectional view taken along line 6-6 of FIG. 6;

FIG. 7 is a front perspective view of the replaceable capsule of the filter of FIG. 1;

FIG. 8 is a side elevation view of the replaceable capsule of FIG. 7;

FIG. 9 is a front elevation view of the replaceable capsule of FIG. 7;

FIG. 10 is a back elevational view of the replaceable capsule of FIG. 7;

FIG. 11 is a side elevation sectional view taken along the line 11-11 of FIG. 10;

FIG. 12 is a front perspective view of the reusable frame of the filter of FIG. 1;

FIG. 13 is a rear perspective view of the reusable frame of FIG. 12;

FIG. 14 is a front elevational view of the reusable frame of FIG. 12;

FIG. 15 is a rear elevational view of the reusable frame of FIG. 12;

FIG. 16 is a side elevational view of personal use filter, according to an embodiment;

FIG. 17 is a rear perspective view of the filter of FIG. 16;

FIG. 18 is a rear perspective view of the filter of FIG. 16, from which the inner shell is removed;

FIG. 19 is a first side elevational exploded view of the filter of FIG. 16;

FIG. 20 is a second side elevational exploded view of the filter of FIG. 16;

FIG. 21 is a perspective exploded view of the filter of FIG. 16;

FIG. 22 is a front elevational view of the filter of FIG. 16;

FIG. 23 is a rear elevational view of the filter of FIG. 16;

FIG. 24 is a side elevational view of a personal use filter, according to an embodiment;

FIG. 25 is a rear perspective view of the filter of FIG. 24;

FIG. 26 is a front perspective sectional view taken along the line 26-26 of FIG. 24;

FIG. 27 is a rear perspective sectional view taken along the line 26-26 of FIG. 24;

FIG. 28 is a first side elevational exploded view of the filter of FIG. 24;

FIG. 29 is a second side elevational exploded view of the filter of FIG. 24;

FIG. 30 is a third side elevational exploded view of the filter of FIG. 24;

FIG. 31 is a rear perspective exploded view of the filter of FIG. 24;

FIG. 32 is a side elevational view of a personal use filter, according to an embodiment;

FIG. 33 is a side elevation sectional view taken along the line 33-33 of FIG. 32;

FIG. 34 is a first side elevational exploded view of the filter of FIG. 32;

FIG. 35 is a second side elevational exploded view of the filter of FIG. 32;

FIG. 36 is a third side elevational exploded view of the filter of FIG. 32;

FIG. 37 is a front elevation view of the filter of FIG. 32;

FIG. 38 is a front perspective view of an end cap of the filter of FIG. 32;

FIG. 39 is a front perspective sectional view taken along the line 39-39 of FIG. 38;

FIG. 40 is a front perspective view of a personal use filter, according to an embodiment;

FIG. 41 is a side elevational view of the filter of FIG. 40;

FIG. 42 is a rear perspective view of the filter of FIG. 40;

FIG. 43 is a side elevational sectional view taken along the line 43-43 of FIG. 41; and

FIG. 44 is a rear perspective sectional view taken along the line 43-43 of FIG. 41.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale, and in some instances, proportions may have been exaggerated in order more clearly to depict certain features of the invention.

Many existing filters are efficient at removing contaminants from air but are expensive and wasteful. In 2018, many disposable activated carbon filters retail for between $60 and $700 CAD. Such filters are typically designed to be employed until the contained absorptive material is used up, after which they are to be disposed of Often the filters are made of materials which are not biodegradable, and if they are recyclable the process of sorting the recyclable components from the other components of the filter is tedious, and many filters end up in landfills.

This description relates to filters which include reusable components to allow a user to have the core filtration medium replaced without needing to replace the entire filter. This description also relates to filters designed to function effectively, and to continue to function effectively after one or more cycles of replacement of the core filtration medium. This description relates to filters which are include a reusable frame and replaceable capsule.

Some embodiments of the present invention relate to filters for use in filtering the air in a room or other enclosed space, such as can-style filters for use in a residential or commercial facility. Some embodiments of the present invention relate to filters for use with personal devices, such as a personal use-style filters for use with cigarettes, vaping devices, and other inhalation devices.

Embodiments of the present invention include an absorptive material space defined by a replaceable capsule and provided to retain a volume of absorptive material as a core filtration material for filtering air, such as a packed volume of loose absorptive material or a layer of absorptive material fabric or some combination. Some embodiments of the present invention will also include one or both of a prefilter and a postfilter in addition to the core filtration material.

In some embodiments of the present invention, the core filtration medium is a filtration fabric held in an absorptive material space defined by a replaceable capsule or is formed of a combination of fabric and loose material. However, in preferred embodiments the core filtration medium is a packed volume of loose absorptive material, such as activated carbon or biochar. In some embodiments, loose absorptive material is machine packed into an absorptive material space defined by a replaceable capsule, such as packed in layers within an absorptive material space.

This description relates to reusable air filters designed not to compromise functionality over time for reusability. In some embodiments, rather than using replaceable carbon sheets or components which quickly break down over time or provide an inferior filtration of air due to less effective components or less effective seals, embodiments of the present invention include a replaceable capsule for containing a machine packed volume of loose absorptive material and for use with a reusable frame.

The frame and capsule may be coupled in a variety of ways, including being screwed into one another, coupled via clips, a spring lock, magnetic fasteners or by some other structure. However, structure which permits easy, durable, and secure fastening is preferred, such as the use of a twist locking structure formed of male and female fastening components. In some embodiments, a button or other release features may be provided to release a locking mechanism to assist in decoupling the frame and capsule. Coupling components may be designed to put minimal stress on hardware, which may reduce the wear and tear on components, which may in turn ensure a more efficient filter and a better customer experience than existing disposable filters, including a longer reusable life. For example, the use of a simple twist lock structure between the capsule and frame may help to ensure that damage or other issues will not keep a user from reusing reusable parts of the filter.

In some embodiments, a handle is also provided, such as a handle fixedly or pivotally secured to the replaceable capsule to allow the user to more easily twist or otherwise manipulate the capsule to release or engage a locking mechanism between the capsule and the frame. The handle may be structure on the bottom or end cap of the capsule to allow ease of handling and use and may be provided in a recess so that the handle, at least when folded away, does not interfere with the ability to set the filter on its bottom end such as to store or transport the filter. A handle may be provided in both a can-style filters and personal use filters, such as projections on personal use filters for interaction with a user's finger or fingernail. In some embodiments, the handle and the hanger slots may be placed in other places than as shown in the figures.

In some embodiments, a filter is designed to be used in a vertical tower position, such as to maximize the effectiveness by enabling the filtration medium to use gravity to provide additional functionality. In some embodiments, this tower style position may require the filter to be provided with an additional curved adapter component to allow the filter to be properly hung in the tower position while simultaneously having the inline fan in its normal horizontal position.

Biochar material or other absorptive material is used in many embodiments of the present invention instead of the more conventional activated carbon, as such material provides better adsorption and bonding properties than many activated carbon materials or provides other benefits. In some embodiments, the biochar may be processed for specific temperatures and pressures, such as from particular biomass material with tailored biochar filter pore size. The pore size may be manipulated to capture specific odorous compounds, such as terpenes in cannabis plants for example. The absorptive material may be processed through the technique of pyrolysis to create tailored biochar, for example. In some embodiments, a mix of loosely packed and machine-packed absorptive material is used.

Improved filters may also use white nano sol, cellulose, biochar, or other absorptive material as the core filtration medium used to purify air, rather than activated carbon. The absorptive material may be chosen based on a balancing of factors such as cost, availability, weight, absorbability, lifespan, sustainability, efficiency, effectiveness, and consumer preference. For example, biochar is often sourced more sustainably than activated carbon, as it comes from renewable sources such as manure, trees, and other organic sources. Activated carbon may also be more expensive and require significantly more energy and land to mine, process, or source than biochar or other materials.

In embodiments which incorporate a filtration fabric, such as part of the core filtration medium, as a prefilter, or as a postfilter, the fabric could be one of a number of filter fabrics. For example, the fabric could be a HEPA filter, a nanofiber fabric filter material, a nano sol filter fabric material, filtration paper, absorbent paper, adsorbent paper, a biochar fabric, or similar materials. In some embodiments a filter fabric is used as part of the support structure, such as forming part or all of the walls of either the frame or capsule or forming part of the walls of the capsule enclosing the volume of absorptive material.

In many embodiments, a prefilter or postfilter is included as part of either the frame or the capsule or as a separate component of the filter, such as a prefilter made of polyester material or other fabric. For example, this may prevent dust and other larger particles from directly entering the filtration or absorption medium inside the filter, since the entrance of such particles could lower the effectiveness of that medium. Where a prefilter or postfilter is a separate component of the filter, the prefilter or postfilter could also be disposable in some embodiments. The prefilter or postfilter may also be biodegradable, such as made of a biodegradable cotton or hemp. The position of the prefilter or postfilter may depend on the intended use of the filter, and in some embodiments a prefilter may function as a postfilter at times and vice versa.

Since covering a filter body with an external prefilter or postfilter can often reduce the reflectance of the filter or have other effects such as aesthetic, in some embodiments any prefilters or postfilters are included inside of the body of a filter, such as covered by a wall of the reusable frame, allowing filters to be used in a greater variety of environments and without requiring further covers; reducing the requirements for complementing components such as casings or dropdown ceilings, and generally increasing the aesthetic appeal. For example, such a configuration may allow for a matte gloss finish over the reusable frame, which may both be aesthetically appealing and may reflect light, as reflecting light is often beneficial in the environments in which filters are used such as in a growing environment or greenhouse.

Many current activated carbon air filters use steel, aluminum and other metals in forming the frame or other structural components. These materials are generally less sustainable than bioplastics and related materials, as they may require a great deal of energy to process, may result in a high carbon footprint, and may require a very tedious process to recycle. Additionally, they may end up in landfills rather than being recycled.

In contrast, some embodiments of the present invention are filters made of a bioplastic, such as hemp plastic. Embodiments of the replaceable capsule may be designed to last 1 to 4 years, depending on what is being filtered and the frequency of use, and can be easily replaced due to the design of the coupling structure and the provision of a convenient handle. The walls and other structure of the capsule may be designed to have a similar effective life as the life of the absorptive material contained in the capsule. In some embodiments, aluminum or steel is used for some components, such as those which are likely to experience a great deal of strain or which are meant for reuse. Some embodiments may also be made, or partly made, of polymers, silicon, or similar composite material.

Embodiments of the present invention do not include rubber gaskets or other sealing components on the reusable frame or other reusable components, as such sealing components can degrade or break. In such embodiments, the rubber gaskets, O-rings or other suction or sealing materials will be featured on the replacement capsule rather than on the frame, so when the filter is ready to be changed, simple removal and replacement of the capsule will be facilitated, creating a fresh new seal. However, in some embodiments no sealing rings or other sealing components are needed as the fit between the frame and capsule may be sufficiently air-tight without such sealing components.

The minimalistic design and concept of embodiments of the present invention allows for less materials, increased convenience, reduced cost, and greater sustainability. Reusable and biodegradable filters reduce waste in the ecosystem, as well as save consumers time during the disassembly process. Including reusable components may prevent thousands of pounds of waste from entering landfills and needlessly destroying the environment. Replacing only part of the filter may also allow for a cheaper effective filter, as users only need to purchase a part of the filter each time the absorptive material expires. The process of replacing spent absorptive material may also be easier with a capsule configuration and an easy locking mechanism. The replaceable components of a filter may also require less energy to produce than the entire filter, such as since bioplastics and other components may require much less energy to process than aluminum and steel and other components of existing filters and metal may only be needed in the frame if at all.

Filters come in several different sizes, and many can-style filters in particular can get quite large. This may make it difficult for a consumer to use, as large filters are often cumbersome and heavy to handle. Since biochar is lighter than many other absorptive materials such as activated carbon, filters using biochar may be easier to handle and place less strain on the user and on filter hardware and on cooperating hardware such as ceiling beams from which a filter is hung. The use of bioplastics may also contribute to weight reduction in some embodiments.

Additionally, as only the capsule needs replacing, embodiments of the present invention may make replacing the absorptive material easier. In addition to being lighter, for filters provided for use with an inline fan the use of a replaceable capsule may speed up the process of replacing the absorptive material as the frame will already be attached to the fan, making replacing the capsule a process done in seconds, rather than minutes as per what is standard.

Currently on the market, there are two different types of can-style filters, regular exhaust filters and inline filters. Consumers must choose which one they will buy. Embodiments of the present invention allow for, and may include, an additional inline sleeve or attachment that individuals can place over the outer reusable frame or replaceable capsule, which will allow for dual functionality, and make two separate products become one. This may allow users to save on the costs of different filters and may give them a more convenient solution if they want to use either type of air filter. It may also use less materials overall instead of creating two separate filters.

Filter type may be chosen based on intended use, with filters for use with inline fans provided for use in filtering the air of a large space such as a residential or commercial room and filters for personal use provided for filtering inhaled or exhaled air for air purification or odor elimination. Filter sizes may be selected either to match environmental constraints, such as the CFM level of an inline fan, or to match desired CFM levels or to meet other constraints.

Embodiments of the present invention may be used for example in residences, laboratories where for example tissue cultures are grown, plant breeding facilities, greenhouses and for indoor gardening, areas where organic fermentation takes places, manufacturing facilities for pollution control, pet stores, pet breeding facilities, pet grooming shops, pet daycares, pet environments which contain odors from animals such as reptiles, industrial environments, paint companies, airports, waste disposal installations, hair salons, clean rooms, hospitals, areas of fabrication, cafeterias, schools, locker rooms, dog runs, commercial facilities, plating facilities that use noxious chemicals restaurants, and sewage treatment plants, and may be used generally to remove volatile organic compounds (‘VOC’) or dust or smog. However, the biochar filters described herein are particularly useful in plant grow operations for pungent plants such as female cannabis plants as an example. Other environments include sulfur treatment, wastewater treatment, and any environment or application where current activated carbon air filters are presently used. This filter could be used for smog treatment and could be used in home or residential applications. Embodiments of the present invention may also be used as personal filtration devices for use in filtering inhaled and exhaled air, such as in connection with vaping devices and other personal inhalation devices and products.

While in some embodiments a fan or other airflow driving structure may be included in a can-style or personal use filter, in preferred embodiments the filter is designed for use with external air flow driving structures such as inline fans or air flow driven by lungs. For filters provided for use with fans there may be coupling structure provided on the frame for coupling to a fan, while for filters provided for personal use the frame may form a mouthpiece for convenient personal use.

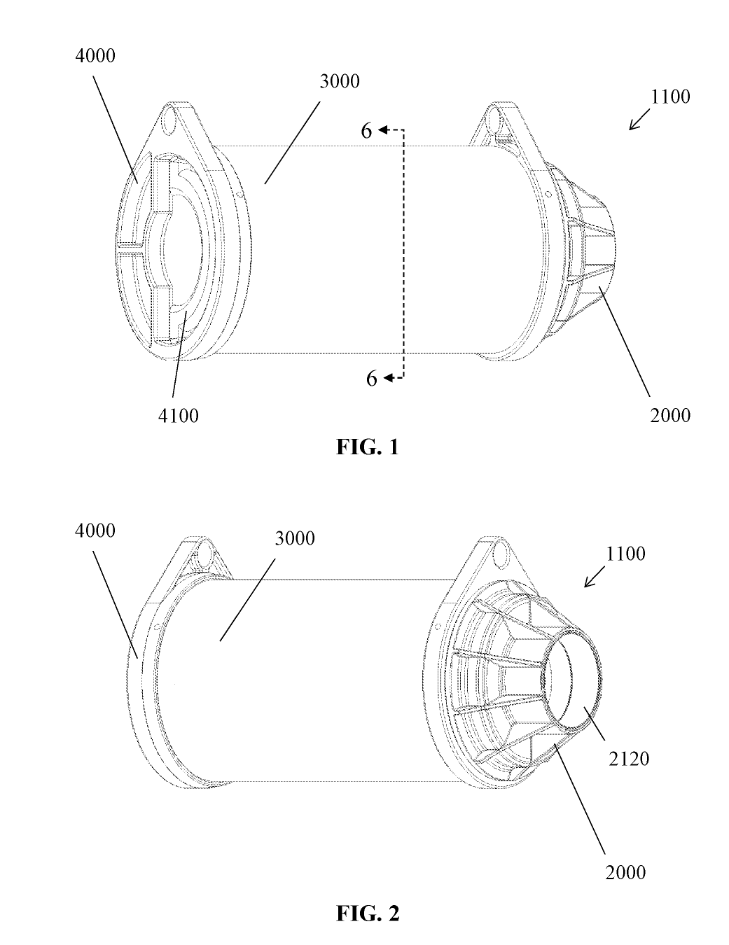

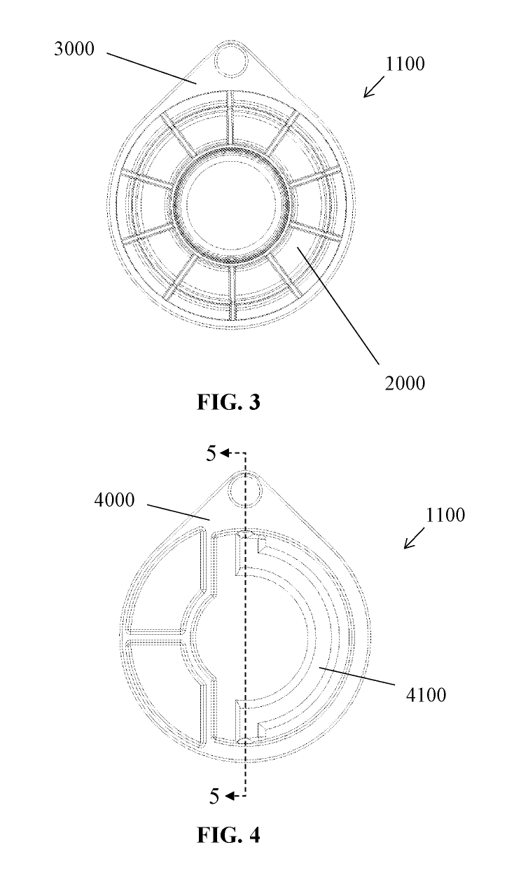

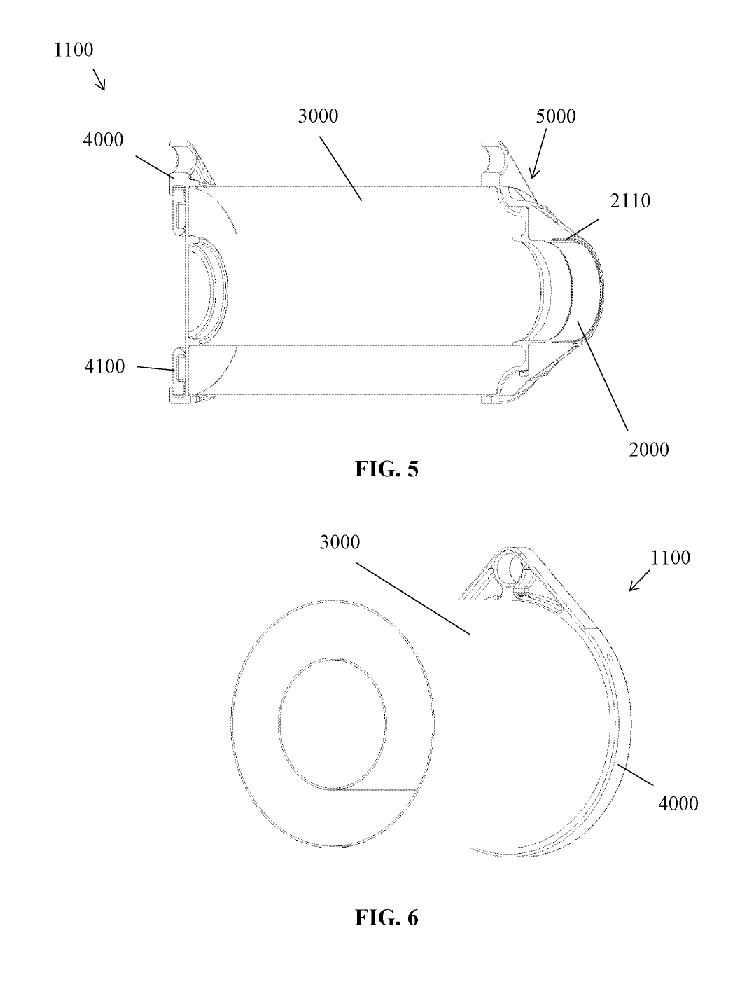

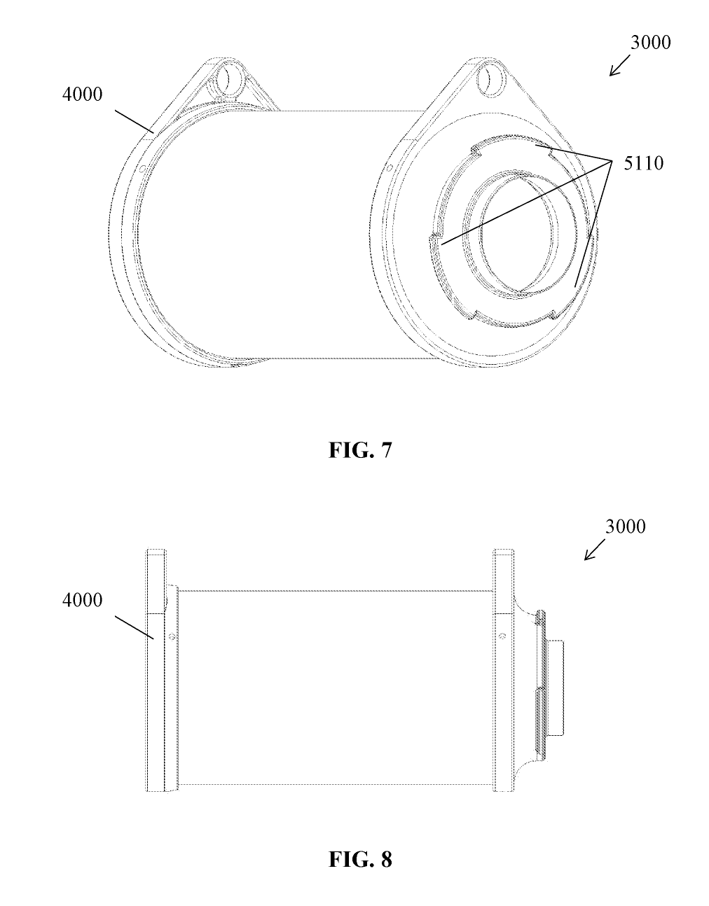

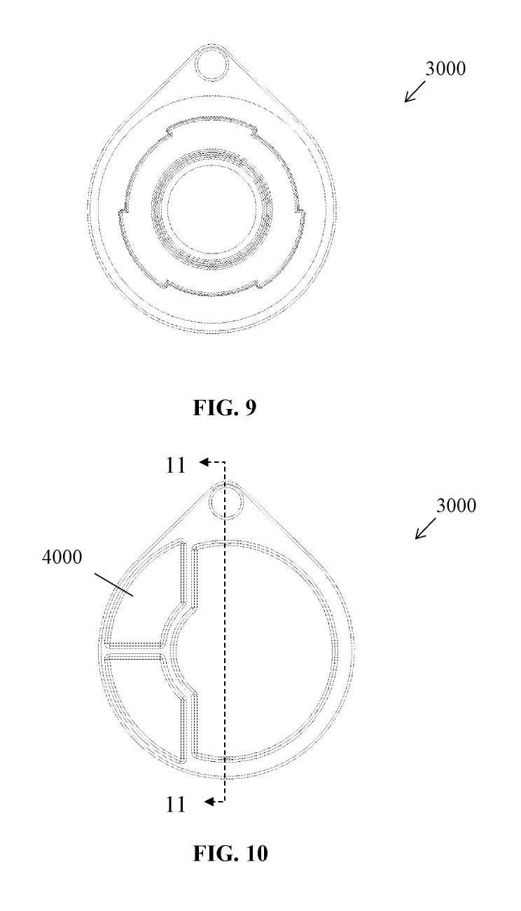

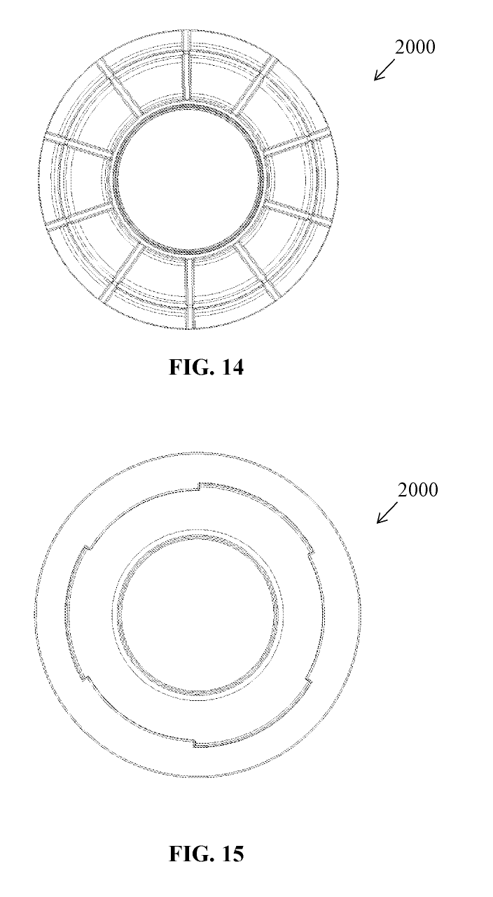

As depicted in FIGS. 1 to 15, an embodiment of the present invention is a can-style filter 1100. Can-style filter 1100 includes a reusable frame 2000 and a replaceable capsule 3000. Filter 1100 also includes a detachable end cap 4000. End cap 4000 may be considered an independent component of the filter 1100 or may be considered a part of either frame 2000 or capsule 3000. In some embodiments, the end cap may be fused to one of the frame or the capsule, such as forming a bottom part of the capsule rather than being an independently removable piece.

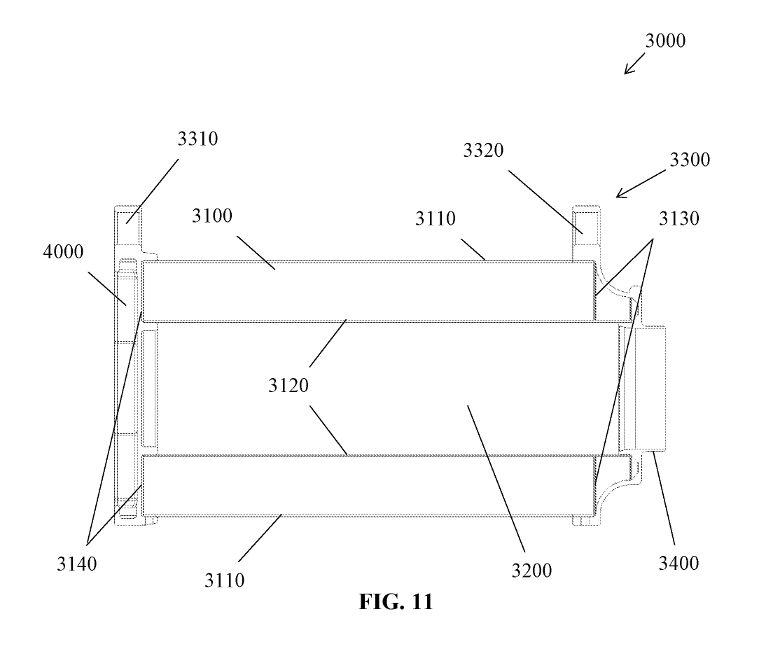

As depicted particularly in FIG. 11, capsule 3000 of filter 1100 includes a drum-shaped canister forming an absorptive material space 3100 to hold absorptive material. The absorptive material space may be designed to be filled with a packed volume of absorptive material or with sheets of absorptive material, such as axially or radially layered sheets of absorptive material. The absorptive material space is radially bounded by an outer wall 3110 and an inner wall 3120 and is also closed at the top and bottom ends by top wall 3130 and a bottom wall 3140.

Capsule 3000 also forms a central passage 3200 to permit fluid such as air to flow freely in though the frame inlet 2120 and be dispersed to the absorptive material space through apertures in the inner wall 3120.

Capsule 3000 also forms a fixture interface structure 3300 for fixing the filter in its environment, such as to hang the filter from a ceiling beam in a commercial or residential room. Fixture interface structure 3300 of filter 1100 includes a first support aperture 3310 and a second support aperture 3320, the first and second apertures 3310 and 3320 provided to allow the filter 1100 to be hung by a cable or rod from environmental structure. In other embodiments, other fixture interface structures could be employed, such as pulleys, clamps or other structure to allow a user to easily hoist or fix the filter in its environment.

Filter 1100 also includes interface structure 5000. As depicted, interface structure 5000 of filter 1100 includes frame interface structure 5100 as part of capsule 3000 and capsule interface structure 5200 as part of frame 2000. Interface structure 5000 is provided to allow the capsule to be coupled to the filter frame. Interface structure 5000 includes male and female coupling components to allow a twist lock. In filter 1100, frame interface structure 5100 includes projections 5110 which are provided to cooperate with projections 5210 of capsule interface structure 5200 formed as part of frame 2000. When coupling frame 2000 and capsule 3000, projections 5110 are passed beyond projections 5210 and then capsule 3000 is twisted relative to frame 2000 such that projections 5110 rest above projections 5210 to hold capsule 3000 coupled to frame 2000. Capsule interface structure 5200 also includes a buffer 5220 to limit the extent to which capsule 3000 can be twisted relative to frame 2000 when projections 5110 are inserted past projections 5210.

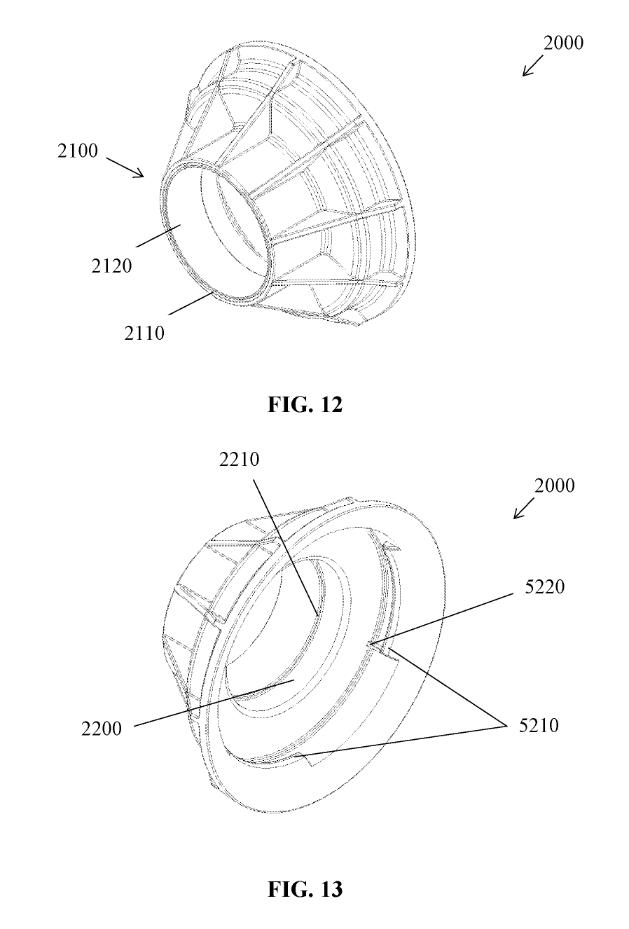

Frame 2000 also includes external interface structure 2100 to allow the frame 2000 to be coupled to an inline fan or other external component. External interface structure 2100 includes a groove 2110, shown particularly in FIGS. 5 and 12, and a frame inlet 2120 through which fluid such as air may flow between a fan and the capsule. In other embodiments, other external interface structure may be provided, such as various clips or friction-fit or other structures.

Filter 1100 may also include at least one pre- or post-filter to filter air before it enters the absorptive material. The location of the pre- or post-filter will depend on the intended direction of air flow but may be wrapped around outer wall 3110 of capsule 3000, may be found inside absorptive material space 3100 against either of walls 3110 or 3120, or may be found inside the central passage 3200 against inner wall 3120.

Filter 1100 forms a filter having a consistent flange width between the opening of the frame 2000 and the inner channel 3200. The frame 2000 and capsule 3000 are formed to maintain a consistent flange, with the capsule including a neck projection 3400 and a cooperating neck indent 2200 in frame 2000. When capsule 3000 and frame 2000 are coupled, neck projection 3400 rests in neck indent 2200, stopped by neck buffer 2210 of frame 2000.

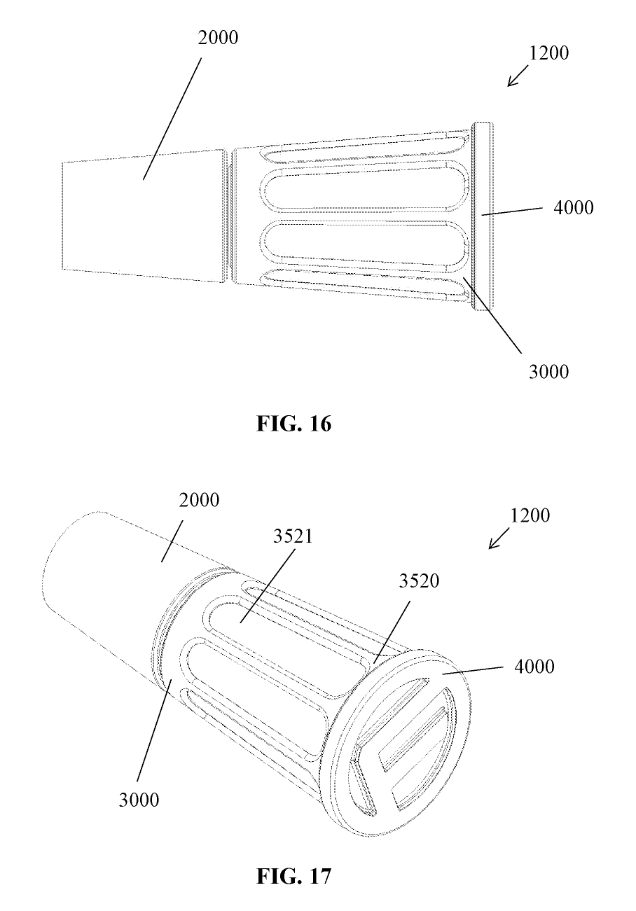

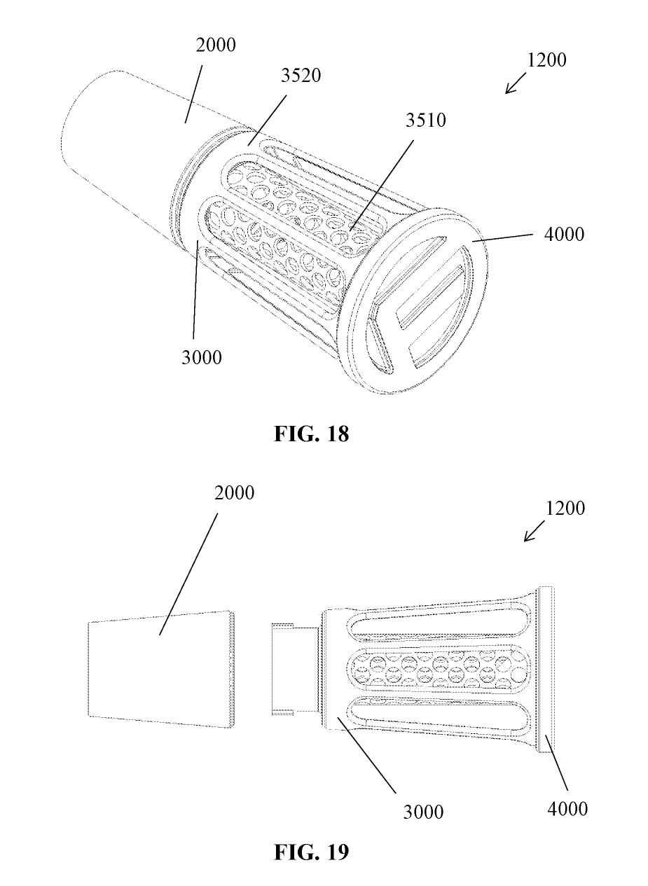

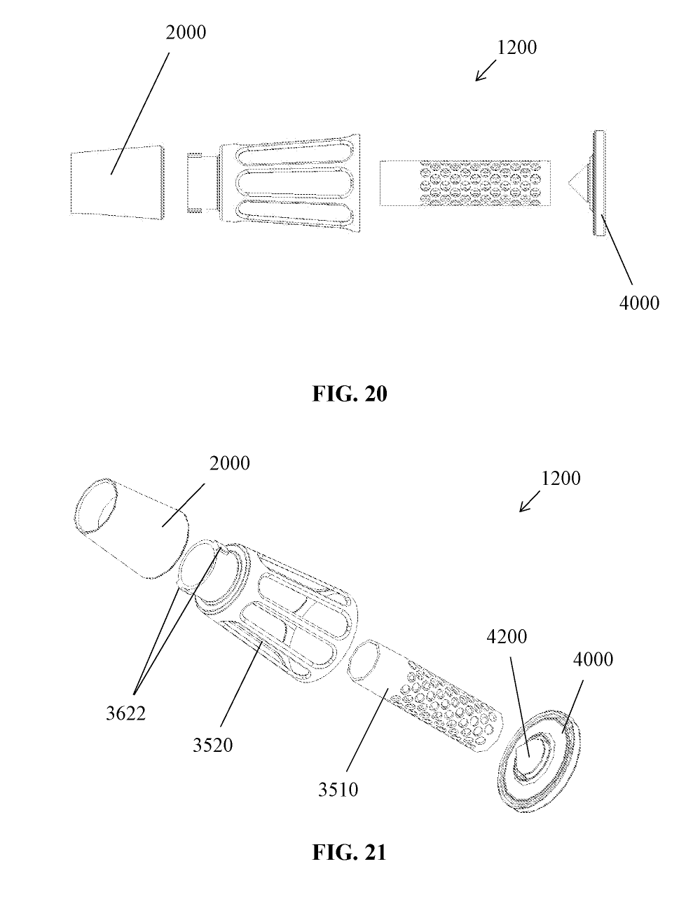

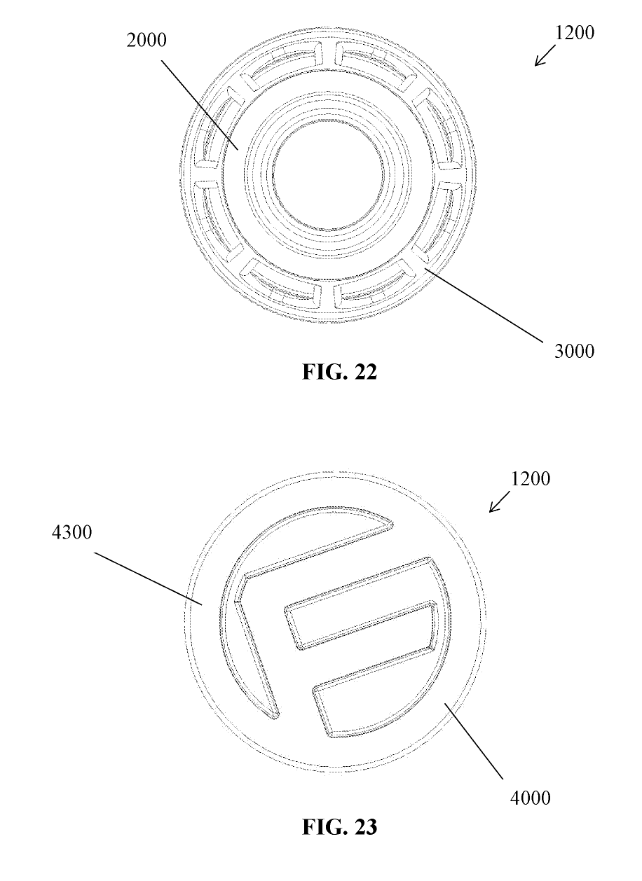

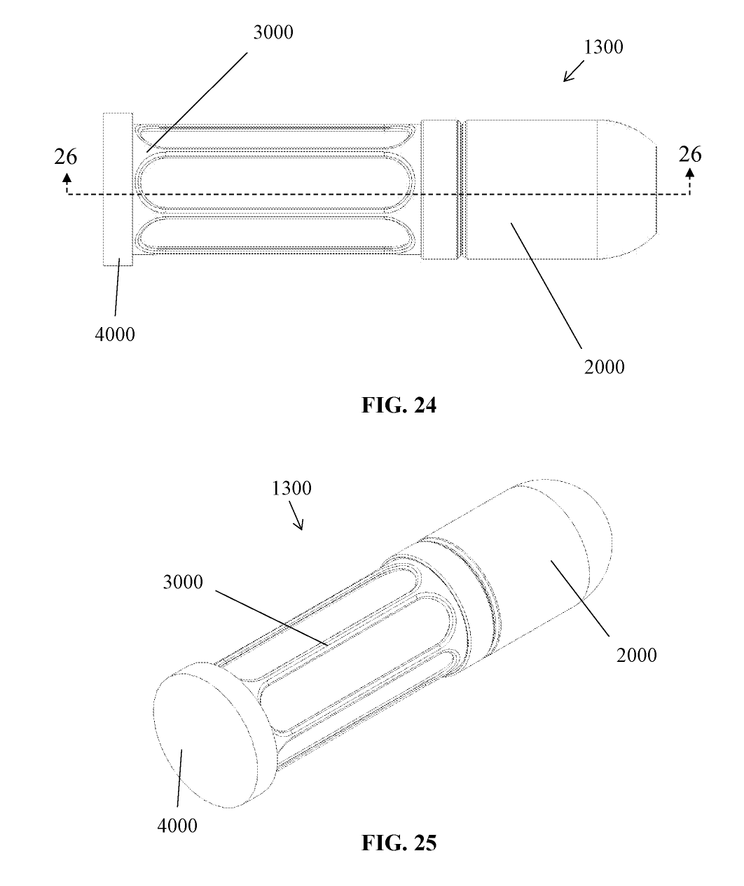

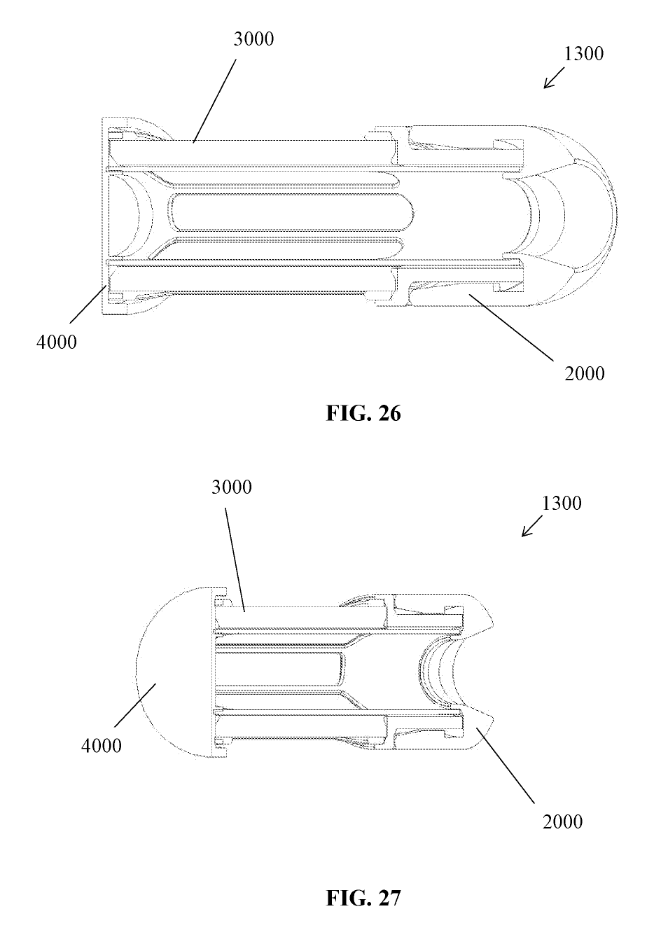

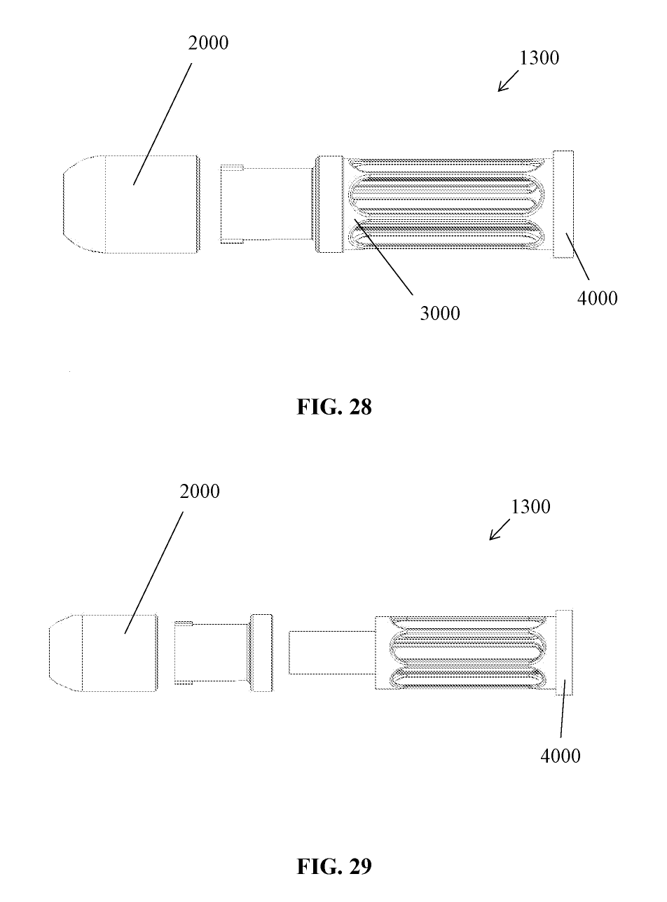

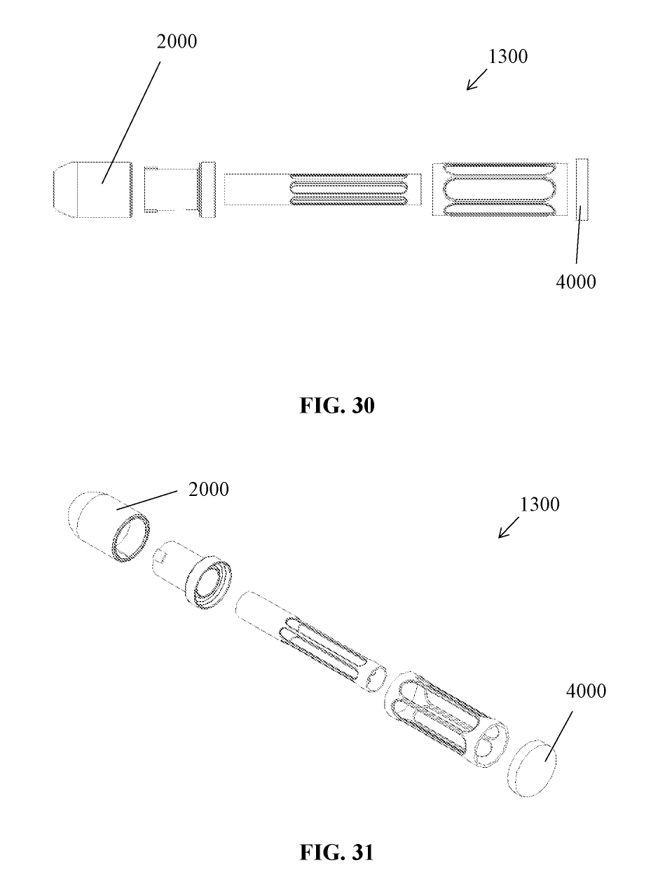

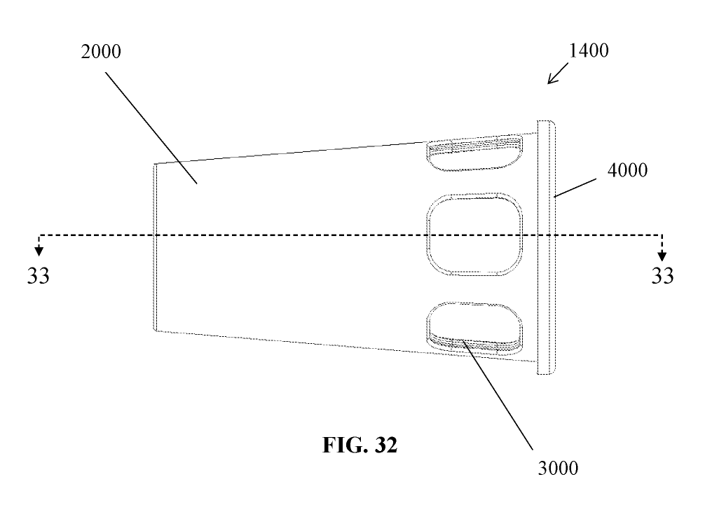

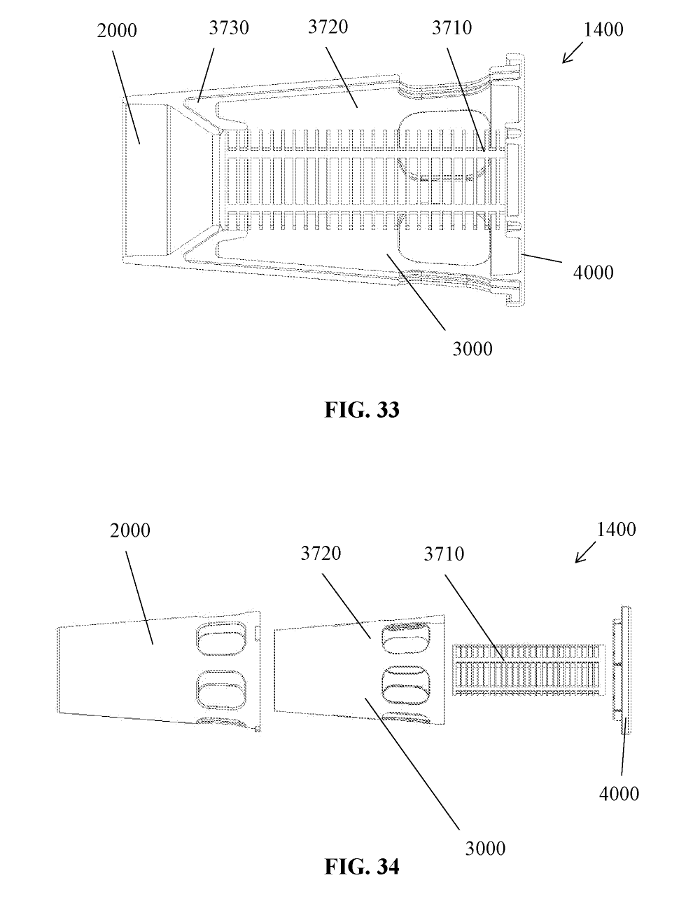

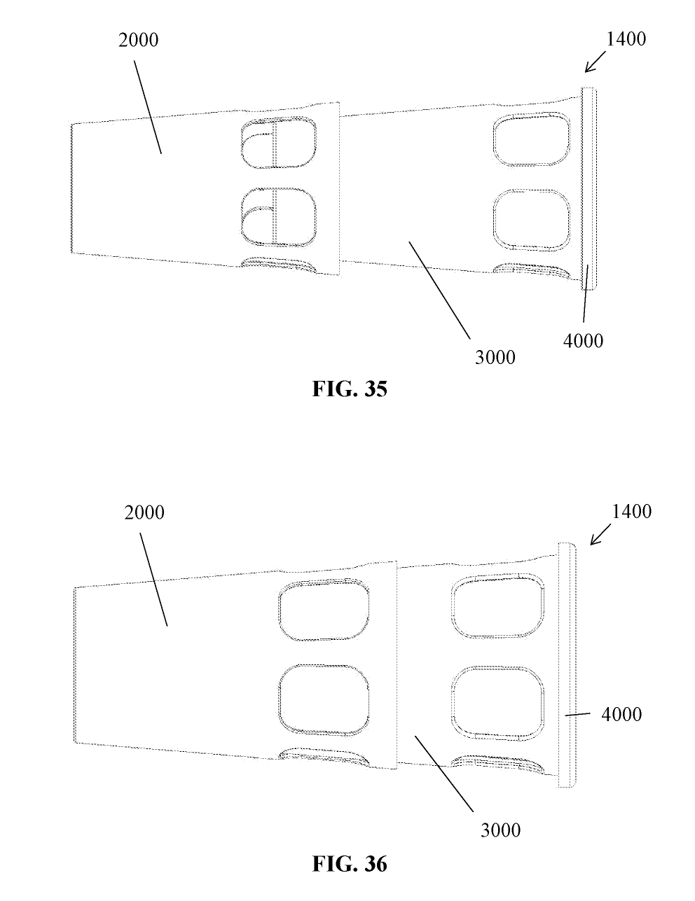

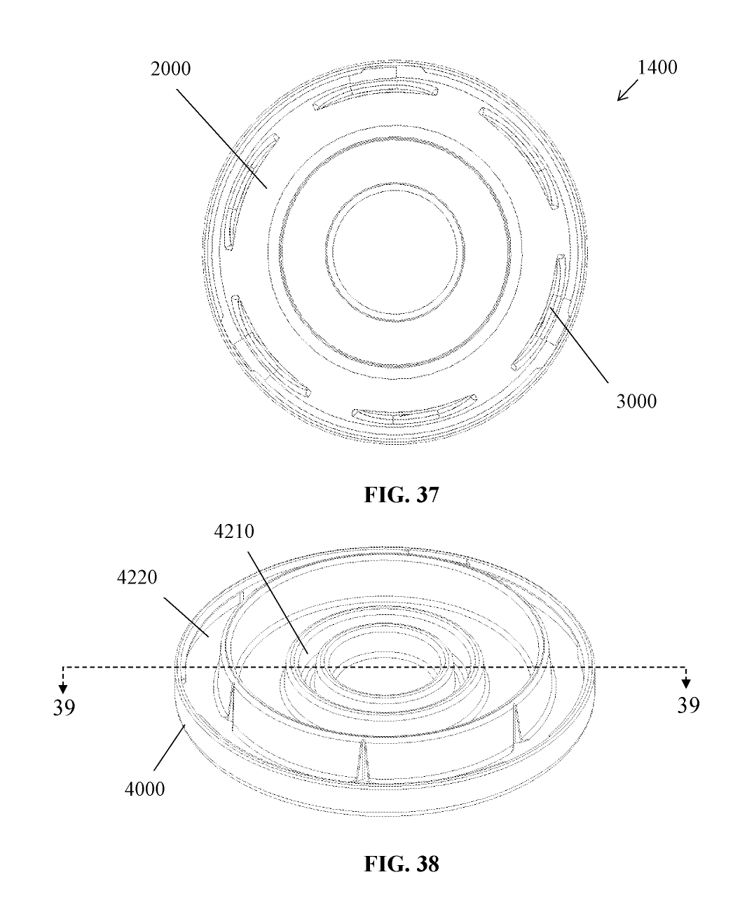

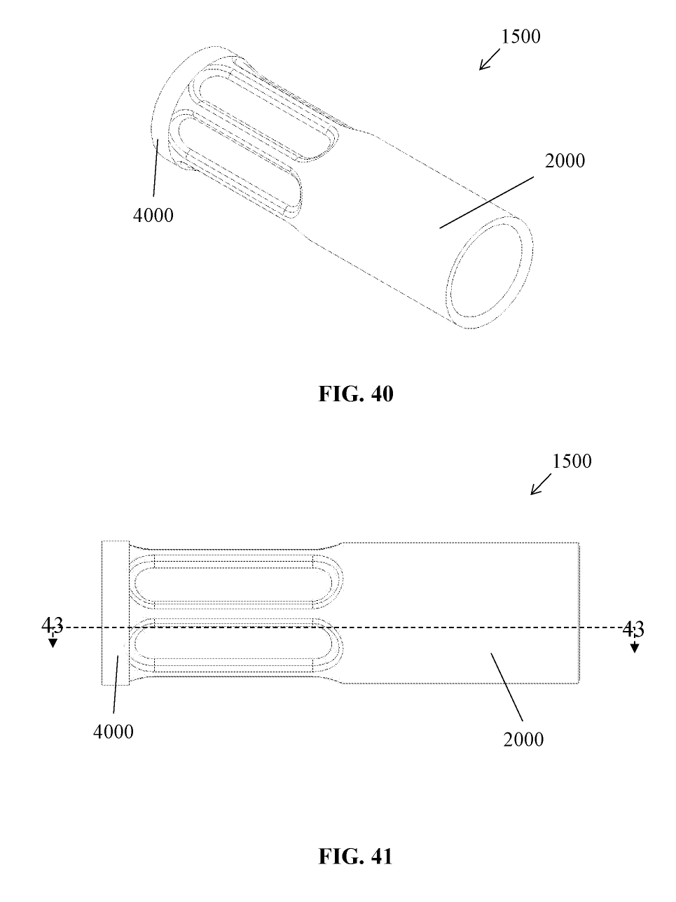

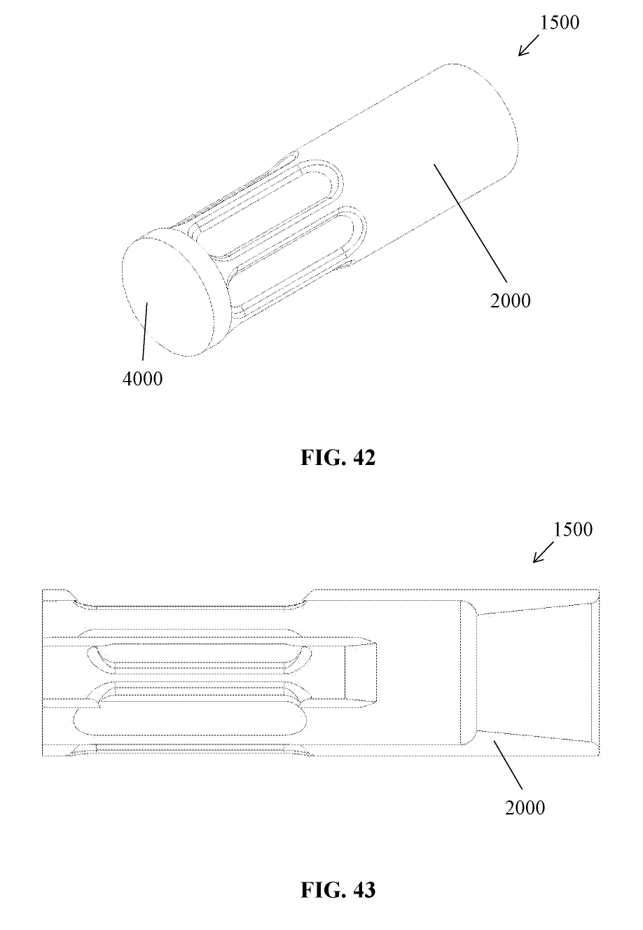

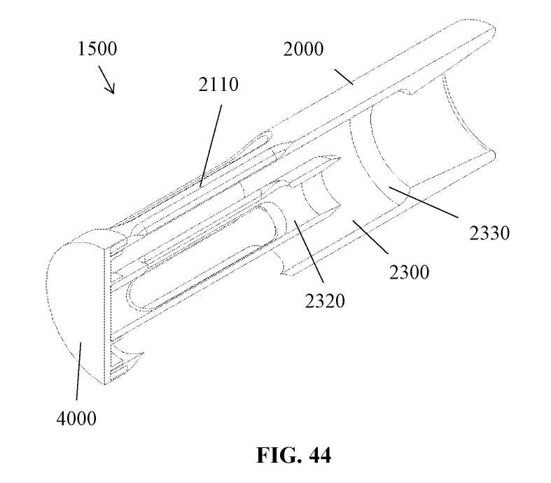

Depicted in FIGS. 16 to 44 are embodiments of personal-use filters. FIGS. 16 to 23 depict a first embodiment having a replaceable capsule body and reusable frame mouthpiece, FIGS. 24 to 39 depict a second embodiment having a replaceable capsule body and a reusable frame mouthpiece, FIGS. 32 to 39 depict a third embodiment having a replaceable capsule core and a reusable frame body, and FIGS. 40 to 44 depict a fourth embodiment having a reusable frame body and a replaceable capsule bag (not shown).

As depicted in FIGS. 16 to 23, a filter 1200 includes a frame 2000 and a capsule 3000. Filter 1200 forms a frustum shape when frame 2000 and capsule 3000 are assembled. Frame 2000 forms a mouthpiece shaped to cooperate with the mouth of a user for exhaling or inhaling through filter 1200. A conical shape may increase functionality by allowing for a larger total volume or surface area of a central passage.

Capsule 3000 of filter 1200 forms an absorptive material receiving space defined by inner wall 3510 and outer wall 3520. In some embodiments, outer wall 3520 is a rib-like structure which includes a mesh or fabric portion 3521 to restrain a volume of absorptive material. The absorptive material receiving space is bounded at a top end by a top wall 3530 and at a bottom end by end cap 4000. Capsule 3000 also includes an inner channel surrounded by the inner wall 3510. End cap 4000 also includes a conical projection 4200 extending into the inner channel to assist in guiding air flow. Capsule 3000 also includes projections 3622 to cooperate with structure on frame 2000 of filter 1200 to form a twist-locking mechanism like that of filter 1100.

As depicted particularly in FIG. 23, end cap 4000 of filter 1200 includes a bottom surface 4300 to which a logo or other mark or message may be applied. In the embodiment depicted, bottom surface 4300 was a substantially flat surface allowing a logo to be added in relief.

As depicted in FIGS. 24 to 39, filter 1300 includes a frame 2000 and a capsule 3000. Filter 1300 is a cylindrically shaped filter for personal use, in which frame 2000 forms a mouthpiece for interfacing with a user's mouth and in which capsule 3000 forms the bulk of the body of filter 1300. Much like filters 1100 and 1200, filter 1300 includes an absorptive material receiving space formed by capsule 3000 and includes twist-lock structure for coupling capsule 3000 and frame 2000.

As depicted in FIGS. 32 to 39, filter 1400 includes a frame 2000 and a capsule 3000. Filter 1400 is again a frustum-shaped filter and includes a frame 2000 which forms an outer shell of filter 1400 into which capsule 3000 is largely received. Capsule 3000 is shaped to fit largely within frame 2000, and again forms an inner channel radially surrounded by an absorptive material space. The absorptive material space is defined by an inner wall 3710 and an outer wall 3720 and by end cap 4000 and a top wall 3730. As depicted, inner wall 3710 is a framework-style wall which may need to co-operate with a fabric sheet or other mesh or sheet cover to retain a packed volume of loose absorptive material. Similarly, outer wall 3710 includes openings which may need to co-operate with a fabric sheet or other mesh or sheet cover to retain a packed volume of loose absorptive material.

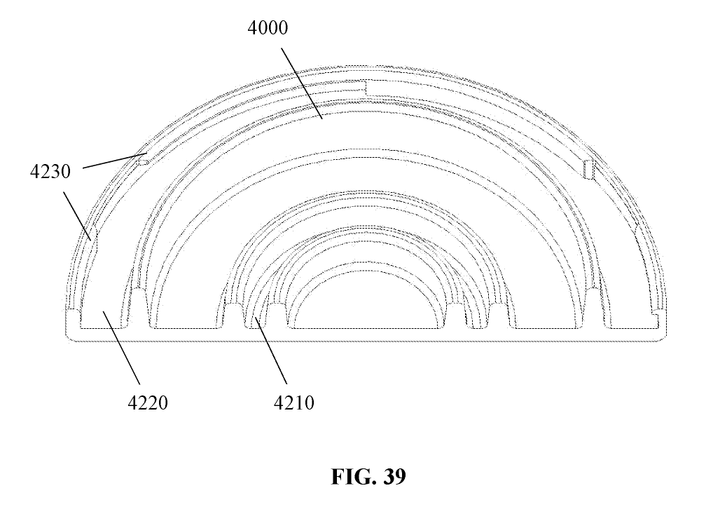

As shown particularly in FIGS. 39 and 40, end cap 4000 includes ridges and grooves provided to hold inner wall 3710 and outer wall 3720 and the shell of frame 2000. Inner groove 4210 is provided to hold inner wall 3710 and outer groove 4220 is provided to hold outer wall 3720 and frame 2000. End cap 4000 also includes projections 4230 to permit end cap 4000 to be secured to frame 2000 using a male and female twist locking structure.

As depicted in FIGS. 40 to 44 filter, 1500 includes a frame 2000 and a capsule (not shown). The frame 2000 of filter 1500 defines a capsule space 2300 via an outer wall 2310, an inner wall 2320, and end cap 4000; the top of capsule space 2300 is open to the rest of the interior of frame 2000 and would be closed by the structure of the capsule when inserted into the capsule space. The capsule of filter 1500 is a bag or other container of a packed volume of loose absorptive material or is a fabric sheet or volume of absorptive material. When end cap 4000 is removed the capsule may be inserted into the capsule space and retained in the capsule space by buffer 2330 of frame 2000 at a top end and by the reattached end cap 4000 at a bottom end.

It is to be understood that the term ‘can-style’ does not necessarily mean that the filter is cylindrical or that it incorporates a central passage such as passage 3200. Similarly, personal use filters may take shapes other than cylinders of frustums and may also not include a central passage. In some embodiments, an absorptive material space may simply be a block of space between a frame inlet and a filter outlet, rather than radially surrounding a central passage. In some embodiments, the absorptive material space in a capsule blocks the diameter of the capsule across an opening from the capsule to the frame, rather than an inner channel radially surrounded by an absorptive material space. However, the use of an inner channel radially surrounded by an absorptive material space may significantly increase the speed with which the filter can filter a volume of air, and thus may be preferred. Additionally, the use of central passage venting laterally may permit the bottom of the end cap to be used as a marketing or logo mount, such as shown in FIG. 23.

Inner and outer walls of the filter, such as inner and outer walls of the capsule, may be fluidly open to allow air to pass into the filter through a top opening, into a capsule, through the absorptive material space defined by the capsule, and out of the filter. For example, such walls may be a fine mesh, may form a set of apertures, or may include filter fabric in areas.

Some embodiments of a personal use filter include a clip holder or attachment piece for a water pipe or vaporizer or cigarette or other smoking device to allow for a personal use filter to be held near the smoking device. In some embodiments, such clips or holders hold the smoking device in proximity to the filter for easy use of one or the other interchangeably, such as to allow a user to inhale smoke an exhale through the filter to remove odors. In some embodiments, such clips or holders hold the smoking device inline with the filter for use concurrently either to filter air being inhaled or to filter air being otherwise released from the smoking device. In some embodiments, the mouthpiece of the frame may also be interchangeable to allow users to switch it out when desired.

In some embodiments, the filter may be integrated with other related structures. For example, the filter may be integrated with a vaporizing or combustion device to allow a user to inhale smoke and exhale to filter odors in one device.

In some embodiments the disposable capsules may also provide a scent. For example, these scents may come from essential oils or dryer sheet type material incorporated into the capsule. For example, a volume of absorptive material may be laced with essential oils which give off pleasant scents as air passes through and may be activated by the passage of air in some embodiments.

In some embodiments, a branded logo may be incorporated on an external surface of the filter, such as on the mouthpiece or bottom of the filter.

In some embodiments, the filter may be sized down to be used with vehicles, such as for odour and smoke elimination. The invention may have an attached fan, which may be powered by the vehicle. The fan could be attached to the outer reusable frame, and the filter may use a variant of replaceable capsule. In other embodiments, the filter may be designed to cooperate with existing air pressure, such as the pressure of air expelled through a tail pipe.

In some embodiments, part of the filter may be integrated with a facility or cooperating device. For example, a filter for use in a portable washroom may include a frame component built into a wall of the portable washroom with the capsule being replaceable. A fan may also be provided as part of the filter or external to it, to drive air through the filter. In another example, the filter may form part of a home ventilation system such as an HVAC system; and such embodiments in particular may include one or more HEPA filter components. In another example, the can-style filter may be incorporated into or designed for use with a refrigerator or other small space. In some embodiments, the filter may be used with a smoker's outpost or other appropriate device and may incorporate an ash tray and may be designed to filter air passing out of the smoker's outpost.

In some embodiments, the filter provides indication of a need to replace a filtration component or is provided for use with an external system which can provide such an indication. For example, a fan may contain an LED light system and sensors and may power a light when the sensors detect that the core filtration medium has expired to alert a user. Sensors could detect a change in the weight of the filter or the core filtration medium, a decline in the effectiveness of the filter, a change in air flow, or some other change. Sensors could include electric sensors, or simple detection indicators such as litmus paper-style sensors which also alert a user by changing color. Sensors and alert elements may be provided as part of the filter in some embodiments.

Particularly where the can-style or personal use filter is provided for use with an integrated fan, it may already require power and so may incorporate a light or other alert indicator which requires power. In some embodiments, a filter may also include a notification system to notify a user of air flow, temperature, humidity and other environmental conditions in a room. Where a fan is included in the filter, the user may also be provided with controls to direct the speed of the fan and other aspects of operation. Some embodiments may include more than one fan.

In some embodiments, the components and biodegradable plastics are designed to meet certain environmental conditions to which it can be expected to be exposed. For example, the biodegradable plastic may have to maintain form and not decompose in humidity conditions from 70-80%. However, this is often not an issue unless the plastic is in direct and prolonged contact with a pool of water. Additionally, in some embodiments humidity of 70-80% will also increase the degradation of the absorptive material. Temperature may also affect the life of the volume of absorptive material, for example the function of the carbon/biochar may slowly diminish as temperatures exceed 50 degrees Celsius. Some embodiments may be designed to cope with such environments or to track their exposure to temperature and humidity levels to predict the life left in the capsule.

Some embodiments of the filter may utilize photocatalytic technology for the degradation of pollutants found within the air. For example, embodiments may utilize light activated catalysts in conjunction with a light source for activation.

Some embodiments utilize ultraviolet radiation elements in conjunction with absorptive material for the effective removal of air pollutants and sanitization of air. This could enable the degradation of pathogens found within the air, including, but not limited to, viruses, bacteria, molds and fungi.

In some embodiments, the disposable capsule is reversible in its direct filtration function. As examples, in some embodiments either end of a capsule can be secured to a frame, in some embodiments the end cap can be opened to provide a filter outlet while the frame inlet is closed to seal the opposing end of the filter, and in some embodiments a frame includes two closable inlets on opposing ends and the capsule can be removably inserted between the two opposing ends. Where a filter is designed for use with an inline fan, embodiments include fan interface structure on one end of the frame to allow the filter to be connected to the fan for use with the fan. However, in some reversable configurations, both ends of a filter may be provided with structure to interface with a fan. Where such interface structure is provided on both ends of a filter, a handle may not be provided at all or may be provided elsewhere on the frame such as on a shell or outer wall of the frame. Reversible filters may enable a user to more evenly use the absorptive material contained in a replaceable capsule by driving air through the absorptive material space from either end of the capsule.

In some embodiments, structural components such as the capsule walls may be manufactured through injection moulding and plastic micro welding. In some embodiments, only some of the structural components may be made of bioplastics and injection molded, for example the capsule may be made of bioplastics and injection molded while the frame may be made of metal such as stainless steel or aluminum to be resistant to rust and corrosion. The filters may be assembled via assembly line in some embodiments.

Embodiments of the present invention may be made from molds using an injection molding process, using significantly less plastic, space, and complexity than forming the components of metal or using other techniques. For example, 3 to 4 molds may be used; one for an end cap, one for a frame and one or more to form the capsule. Where more than one mold are used to form a part of the filter, the resultant pieces may be formed together in a variety of ways, such as via plastic wielding. Since in some embodiments the reusable outer frame or disposable capsule will not be molded in entirety, some savings may be realized on shipping, production and component costs.

Manufacturing using filtration mesh netting, nylon stocking and other biodegrading netting may make the disposable capsule biodegradable, while still being functional and cost effective to produce. A filter may also be able to be more compact than usual, such as with a thinner absorptive material bed, when the absorptive material used is more effective than typical material.

The moulds of the design may scalable and may be designed to minimize the use of plastic. For example, the use of multiple molds to create a component such as the replaceable capsule may enable the resulting component to have thinner walls and more precise dimensions and thus use less plastic.

Embodiments may be configured to hold a volume of absorptive material that will last 3 to 8 months of regular use, though the volume required may depend on the frequency of use and the type of air being filtered. For example, filtering cigarette smoke from air may more quickly utilize the absorptive capacity of most martials than filtering other types of smoke.

While walls, such as radial walls, have been depicted as smooth single walls of a continuous radius, such walls could also be formed of multiple layers with interior gaps, could include surface texturing, and could have varying radius. Embodiments of the present invention could also be formed otherwise than in the cylindrical structure of most of the depicted embodiments, other structures could include rounded or circular shapes or others.

In some embodiments of the present invention the walls of the filter, such as the inner and outer walls of the capsule, may include clearly defined hole structures. Hole size and distribution may be uneven in some embodiments, such as to modulate the air pressure within the absorptive material volume. In other embodiments, the hole size and distribution may be even, such as to ensure that the orientation of the capsule and other components is not an issue.

In some embodiments, the filter includes hole structures designed for optimal air flow. The hole structure in the walls of the filter may be a mesh, a plurality of holes, a plurality of swirls, small holes, square holes, hexagon shapes, or other openings chosen to retain the volume of absorptive material while allowing air to pass through. The hole structure may also vary across the body of any particular component, such as holes of varying sizes, with hole size changing from smallest to largest, or largest to smallest, from the flange side that is attached to the inline fan to the end cap with the handle piece. This may reduce vena contracta issues and increase air flow efficiency equally within the filter.

The filter can be made using an array of colors and may have unique technologies and methods for painting them. A matte finish, along with a unique design may be present. In some embodiments, the filter can be colored white as white reflects light which is beneficial in a cultivation setting. The reusable outer frame may be coated in a matte gloss finish to further reflect light.

In some embodiments, molds may be provided to form the components of an air filter, so that the filters may be made in mass amounts. These molds could be both integral and unique to the invention due to its ability to be made using plastic.

In some embodiments, the capsules are designed to be returned, melted down, and materials replaced, which may prevent the perpetual waste of steel and aluminum.

As machine packing is often necessary for maximum efficiency of absorptive material, such as biochar material, the capsule nature of the product may assist in maximizing the efficiency of the filter.

Various embodiments of the invention have been described in detail. Since changes in and or additions to the above-described best mode may be made without departing from the nature, spirit or scope of the invention, the invention is not to be limited to those details but only by the appended claims.

What is claimed is:

1. A filtration apparatus for filtering air, comprising:
a disposable capsule defining an absorptive material space to hold a volume of absorptive material, the disposable capsule further defining a set of capsule fluid inlets to permit fluid to move through the disposable capsule into and out of the absorptive material space; and
a reusable frame to support the disposable capsule, the reusable frame defining a frame fluid inlet, and
wherein the reusable frame is removably couplable to the disposable capsule to direct fluid passing through the filtration apparatus through a fluid passage through the frame fluid inlet and the absorptive space of the disposable capsule.

2. The filtration apparatus of claim 1, wherein the disposable capsule further defines a central passage and the absorptive material space radially surrounds the central passage.

3. The filtration apparatus of claim 2, wherein the reusable frame forms a filtration apparatus outer shell and the disposable capsule is a fabric envelope to contain an absorptive material and to be received within and supported by the reusable frame.

4. The filtration apparatus of claim 3, wherein the fabric envelope is an absorptive material fabric.

5. The filtration apparatus of claim 2, wherein the filtration apparatus is a canister filter for use with an external inline fan.

6. The filtration apparatus of claim 2, wherein the filtration apparatus includes the fan.

7. The filtration apparatus of claim 2, wherein the filtration apparatus is a personal use filter and includes a filtration apparatus mouthpiece.

8. The filtration apparatus of claim 2, wherein the absorptive material space is provided to hold a packed volume of loose absorptive material.

9. The filtration apparatus of claim 2, wherein the absorptive material space is provided to hold a filtration fabric.

10. The filtration apparatus of claim 2, wherein the filter includes a twist lock for coupling the disposable capsule and the reusable frame.

11. The filtration apparatus of claim 2, wherein the disposable capsule includes at least one sealing member, configured to rest between the disposable capsule and the reusable frame to form part of the fluid passage.

12. The filtration apparatus of claim 11, wherein the at least one sealing member is a flexible O-ring.

13. The filtration apparatus of claim 2, wherein at least one of the disposable capsule and the reusable frame is formed of bioplastic.

14. The filtration apparatus of claim 13, wherein at least one of the disposable capsule and the reusable frame is formed by injection molding.

15. The filtration apparatus of claim 2, further comprising a volume of absorptive material received in the absorptive material space.

16. The filtration apparatus of claim 15, wherein the absorptive material is a biochar material.

17. The filtration apparatus of claim 2, wherein the fluid passage further passes through a prefilter.

18. The filtration apparatus of claim 2, wherein the disposable capsule includes a fixedly secured handle to allow a user to twist the disposable capsule relative to the reusable frame.

19. A set of injection molds for forming a disposable air filter capsule, comprising:
a frame end injection mold for forming a reusable frame defining a frame inlet;
an end cap injection mold for forming an end cap; and
at least one capsule injection mold for forming a replaceable capsule defining an absorptive material space,
wherein the reusable frame, end cap, and replaceable capsule are configurable to form a filtration apparatus defining a fluid passage through the frame inlet and the absorptive material space.
